(19) United States
(12) Patent Application Publication
(10) Pub. No.: US 2008/0093401 A1
(43) Pub. Date: Apr. 24, 2008

(54) Golf Car Cup Holder

(75) Inventors: Donald S. Hanson, Evans, GA (US); Bradley J. Hanson, North Augusta, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/959,529

(22) Filed: Dec. 19, 2007

Related U.S. Application Data
(63) Continuation-in-part of application No. 11/176,000, filed on Jul. 6, 2005.

(51) Int. Cl. B60R 7/06

(52) U.S. Cl. 224/274; 206/315.9; 224/483; 248/311.2

(57) ABSTRACT

A golf ball holder for a golf car includes a cylindrical wall portion with an opening that is located at an intersection of the cylindrical wall portion and a skirt portion that bounds a periphery of a drink holder module. A golf ball supporting surface spans one end of a golf ball retaining space which is defined by the cylindrical wall portion. A second end of the golf ball retaining space is open and allows golf balls to pass through. The opening provides finger access to the golf ball retaining space.

### CROSS-REFERENCE TO RELATED APPLICATIONS

This application is a continuation-in-part of U.S. patent application Ser. No. 11/176,000 filed on Jul. 6, 2005. The disclosure of the above application is incorporated herein by reference.

### FIELD OF THE INVENTION

The present invention relates to receptacles for holding golf balls.

### BACKGROUND OF THE INVENTION

Drink holders are mounted in many vehicles to provide operators and passengers with convenient places to set their drink containers. As drink containers have become increasingly “super-sized”, known drink holders have been devised to accommodate containers of varying sizes. These drink holders generally have a moving member to accommodate the various diameters of containers. While such drink holders may be suitable for use in many vehicles, they are generally unsuitable for use in a golf car.

Golf cars, which include small vehicles used and/or rented for uses such as transporting sportsmen afield, parking lot shuttles, and so forth, are often driven across hilly and bumpy terrain and therefore present unique problems in designing drink holders. In addition to accommodating drink containers of varying diameters, the drink holders should also minimize maintenance costs related to repairing or replacing broken drink holder parts. The drink holders should also be easy to clean to reduce the time needed to clean the golf car and make it available to rent or use again. Furthermore, the drink holders should be designed to minimize time needed for assembling the golf cars.

### SUMMARY OF THE INVENTION

A golf ball holder for a golf car includes a cylindrical wall portion with an opening that is located at an intersection of the cylindrical wall portion and a skirt portion that bounds a periphery of a drink holder module. A golf ball supporting surface spans one end of a golf ball retaining space which is defined by the cylindrical wall portion. A second end of the golf ball retaining space is open and allows golf balls to pass through. The opening provides finger access to the golf ball retaining space.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a perspective top view of a drink holder module;

FIG. 2 shows a perspective partial bottom view of a drink holder module;

FIG. 3A shows a cross section of a multiple diameter receptacle having pliable members;

FIG. 3B shows a cross section of a multiple diameter receptacle having pliable members;

FIG. 4 shows a cross section of a mold;

FIG. 5 shows a perspective view of an instrument panel (IP) for mating with a drink holder; and

FIG. 6 shows a perspective view of a drink holder module that includes one or more golf ball holders.

### DETAILED DESCRIPTION OF THE PREFERRED EMBODIMENTS

The following description of the preferred embodiment(s) is merely exemplary in nature and is in no way intended to limit the invention, its application, or uses.

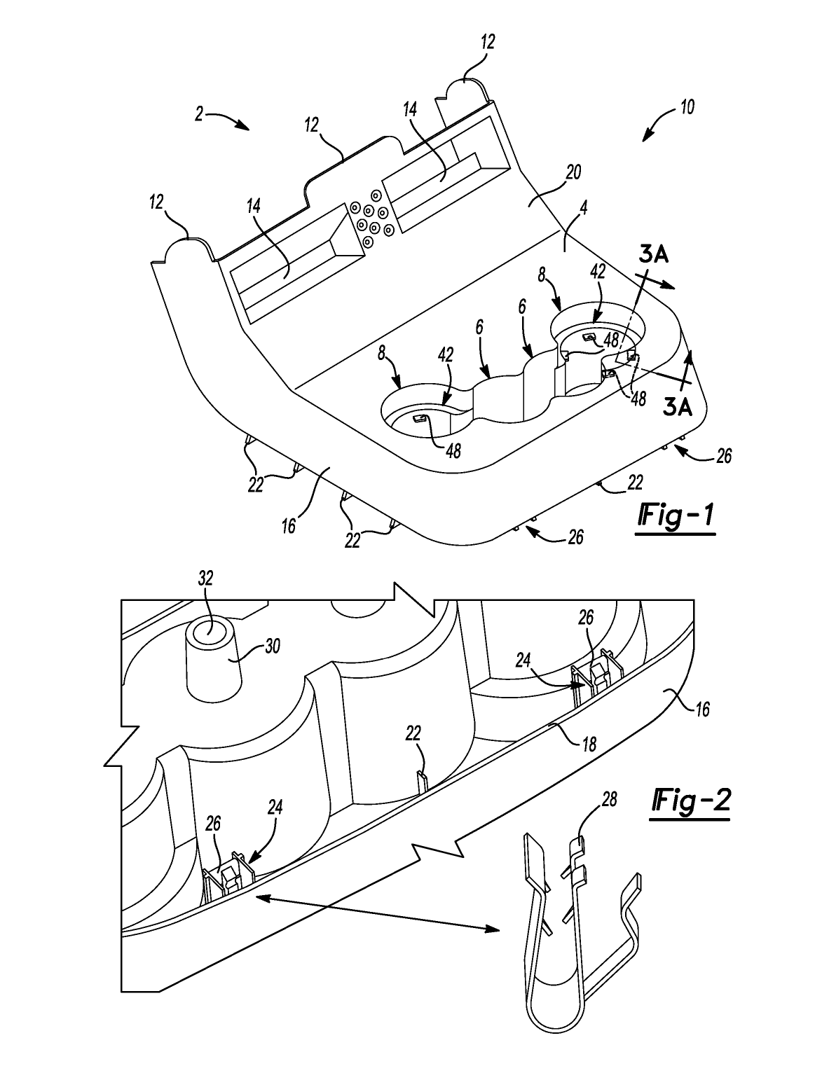

FIG. 1 shows a drink holder module 2 arranged in accordance with the present invention. The module 2 has a trim surface 4 with single diameter receptacles 6 and multiple diameter receptacles 8 disposed therein. The receptacles 6, 8 may be arcuately arranged with each receptacle partially intersecting one or more adjacent receptacles 6 and/or 8. The module 2 also has a vertical portion 10 having a plurality of protrusions 12 for securing the vertical portion 10 to an adjoining structure. The vertical portion 10 may include one or more storage bins 14. A skirt portion 16 having a bottom edge 18 (shown in FIG. 2) surrounds the trim surface 4. The bottom edge 18 may engage an adjoining structure as described later herein. The module 2 may include an integral fillet panel 20 to provide an aesthetic transition between the trim surface 4 and the vertical portion 10.

FIG. 2 shows a bottom view of the module 2. An interior of the skirt portion 16 has one or more alignment features 22 and one or more attachment points 24. The alignment features 22 protrude beyond the bottom edge 18 of the skirt portion 16. The alignment features 22 may engage with a mating feature, such as a slot, in the adjoining structure to align the module 2 with the adjoining structure. The attachment points 24 have a planar portion 26 generally parallel to the interior of the skirt portion 16. A clip 28, such as a Tinnerman type clip, secures to the planar portion 26 to the adjoining structure, thereby securing the module 2 to the adjoining structure. A drain nipple 30 has a through-hole 32 to an interior of its associated receptacle 6, 8. The through-hole 32 provides a path for liquid to drain from the receptacles 6, 8, thereby facilitating washing and rinsing the receptacles 6, 8.

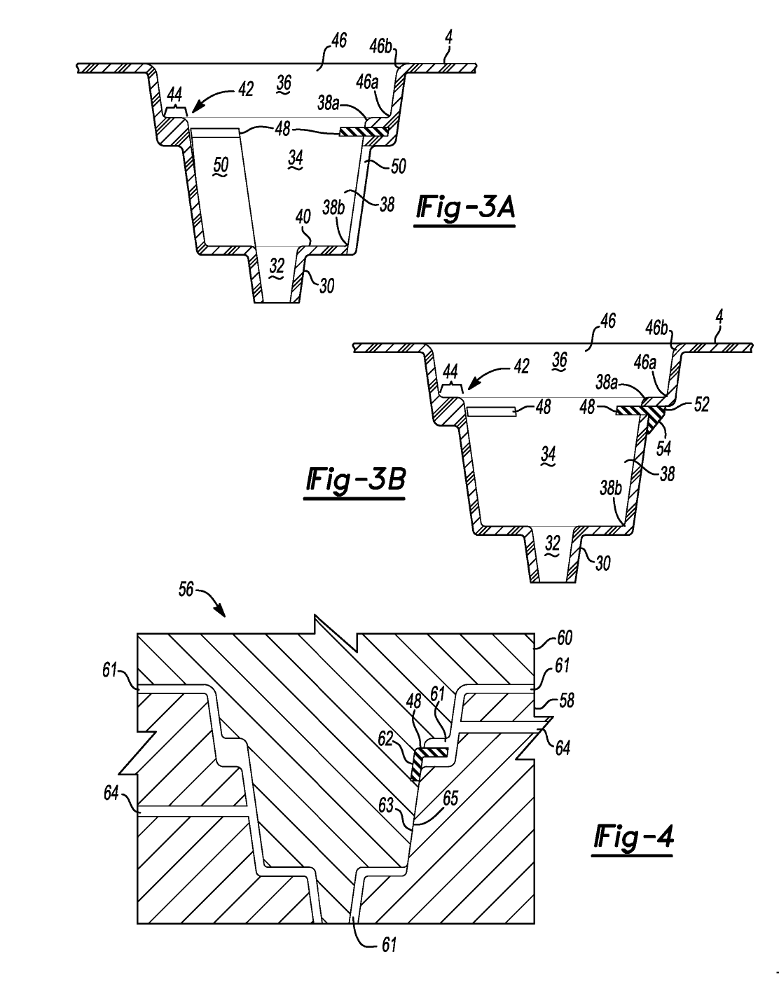

FIG. 3A shows a cross-section view taken through section lines 3A-3A of FIG. 1. The multiple diameter receptacle 8 has a lower receptacle 34 and an upper receptacle 36. The lower receptacle 34 has a first curved wall 38 having a top 38a and a bottom 38b. A support portion 40 extends radially inward from the bottom 38b of the first curved wall 38. The through-hole 32 penetrates the support portion 40 to provide a drain for the multiple diameter receptacle 8. A support ring 42 has a flat surface 44 extending radially between the top 38a of the first curved wall 38 and a bottom 46a of a second curved wall 46. A top 46b of the second curved wall is integral with the trim surface 4.

The support ring 42 provides support for containers having a bottom diameter greater than a diameter of the lower receptacle 34 and less than a diameter of the upper receptacle 36. Vertically positioning the support ring 42 closer to the top 46b than to the bottom 38b increases the likelihood that the bottom of such a container will rest upon the support ring 42, even when the container has an external diameter that increases along a vertical axis.

The multiple diameter receptacle 8 may also have a plurality of pliable members 48 integrally molded with the support ring 42 and protruding radially inwardly from the first curved wall 38. The pliable members 48 secure drink containers having a diameter less than a diameter of the lower receptacle 34 by deflecting downwardly as the container is inserted in the lower receptacle 34. Once the container is in the lower receptacle 34, the pliable members 48 apply a retaining force against a sidewall of the container, thereby holding the container in place. Depending on a method chosen to integrally mold the pliable members 48, a slot 50 may be disposed in the first curved wall 38 between each pliable member 48 and the bottom 38b. As described later herein, the slots 50 allow a simple two-piece mold to be used to integrally mold the pliable members 48. The drain nipple 30 is integrally molded with the support portion 40.

It should be noted that throughout the specification like reference numerals will refer to like elements. FIG. 3B shows an alternative method for securing the pliable members 48. A radially outward portion 52 of each pliable member 48 may have one or more barbs 54 for engaging an exterior portion of the first curved wall 38. The barbs 54 secure the pliable member 48 in position.

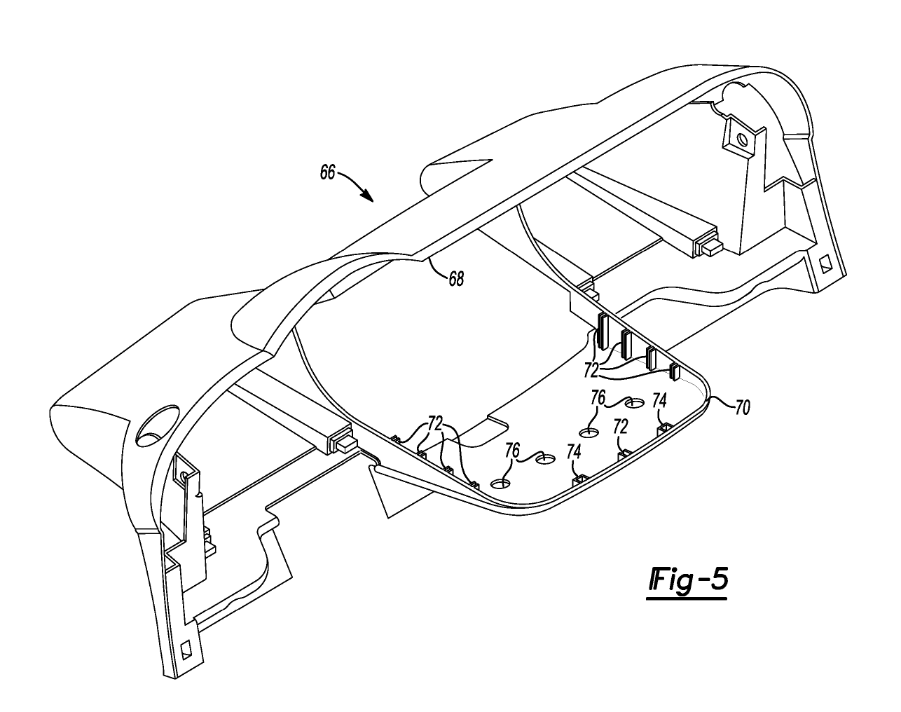

FIG. 4 shows a mold 56 suitable for forming the multiple diameter receptacle 8 of FIG. 3A. A first mold portion 58 forms an exterior surface of the multiple diameter receptacle 8. A second mold portion 60 forms an interior surface of the multiple diameter receptacle 8. A void 61 is formed between the first and second mold portions 58, 60. A recess 62 temporarily bends and secures a portion of the pliable member 48 such that a remainder of the pliable member 48 is positioned in a portion of the void 61 that forms the support ring 42. Injection ports 64 provide a path for introducing a molding material, such as a heated thermoplastic olefin, to the mold cavity 61. A pair of contacting mold surfaces 63, 65 are located below the recess 62 and prevent the molding material from undesirably molding over the portion of the pliable member 48 that is temporarily held in the recess 62. The contacting mold surfaces 63, 65 also form the slot 50. As the molding material sets, the remainder of the pliable member 48 becomes integrally molded with the support ring 42. When the first and second mold portions 58, 60 are separated, the portion of the pliable member 48 springs free from the recess 62 and protrudes radially inwardly from the first curved wall 38.

FIG. 5 shows an instrument panel 66 for providing the adjoining structures for the drink holder module 2. The instrument panel 66 has a top portion 68 for receiving the plurality of protrusions 12. A support periphery 70 mates with the skirt portion 16. The support periphery has mating alignment features 72 and mating attachment points 74. The mating alignment features 72 receive the alignment features 22 integrally molded in the drink holder module 2. The mating attachment points 74 are engaged by the clips 28 to secure the drink holder module 2 to the instrument panel 66. The instrument panel 66 may also include one or more holes 76 for allowing the drain nipples 30 to protrude down through the instrument panel 66.

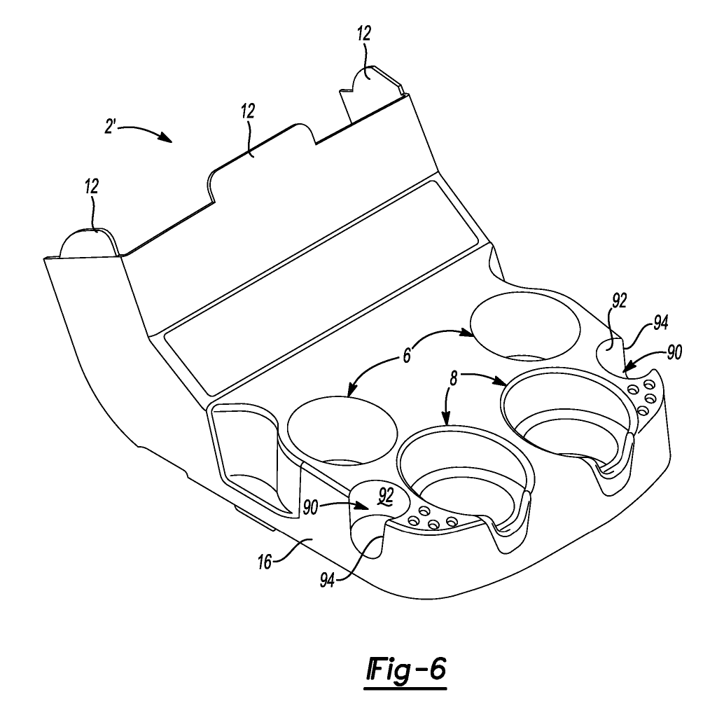

FIG. 6 shows one of several embodiments of a second cup holder module 2′ which includes one or more golf ball holders 90. Golf ball holder 90 retains a golf ball under all reasonable driving modes of a golf car. Golf ball holder 90 also can also be molded simultaneously with much of the remainder of cup holder module 2′.

Each golf ball holder 90 includes a cylindrical wall portion 92 that intersects with skirt portion 16. An opening 94 is located at the intersection of cylindrical wall portion 92 and skirt portion 16. Opening 94 can be a slot that is generally parallel with the axial axis of cylindrical wall portion 92. One end of the slot can be left open to facilitate lifting or rolling a golf ball from holder 90. A shape of the second end of the slot can be based on a shape of a bottom of the ball holder. To facilitate draining liquids from golf ball holder 90, the bottom of the second end of the slot can be lower than a golf ball supporting surface at the bottom of golf ball holder 90. In some embodiments a depth of golf ball holder 90 is greater than a width or diameter of cylindrical wall portion 92. The depth can be measured along the axial axis of cylindrical wall portion 92. A first endpoint of the depth is located at an intersection of the axial axis and the plane of trim surface 4. A second endpoint of the depth is located at an intersection of the axial axis and the golf ball supporting surface at the bottom of golf ball holder 90.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A golf ball holder for a golf car, comprising:
a cylindrical wall portion with an opening that is located at an intersection of the cylindrical wall portion and a skirt portion that bounds a periphery of a drink holder module; and
a golf ball supporting surface that spans one end of a golf ball retaining space which is defined by the cylindrical wall portion, wherein a second end of the golf ball retaining space is open and allows golf balls to pass through and wherein the opening provides finger access to the golf ball retaining space.

2. The golf ball holder of claim 1 wherein the opening is parallel with an axial axis of the cylindrical wall portion.

3. The golf ball holder of claim 1 wherein a portion of the opening that is nearest the golf ball supporting surface is lower than a lowest portion of the golf ball supporting surface such that liquids poured into the golf ball retaining space totally drain through the opening.

4. The golf ball holder of claim 1 wherein a diameter of the golf ball retaining space is less than its depth.

5. A drink holder for a golf car, comprising the golf ball holder of claim 1;
a lower receptacle having a first curved wall having a top and a bottom;
a support portion integrally formed with the first curved wall and extending radially inward from the bottom of the first curved wall;
an upper receptacle having a second curved wall having a top and a bottom; and
a support ring having a flat surface extending radially between the top of the first curved wall and the bottom of the second curved wall.

6. The drink holder of claim 5 wherein the support ring is positioned closer to the top of the second curved wall than to the bottom of the first curved wall.

7. The drink holder of claim 5 further comprising at least one pliable member projecting radially inward from the first curved wall.

8. The drink holder of claim 7 wherein the at least one pliable member is integrally formed with the support ring.

9. The drink holder of claim 7 wherein the at least one pliable member further comprises at least one barb protruding from a radially outward portion, the at least one barb engaging an exterior portion of the first curved wall.

10. The drink holder of claim 5 further comprising an axial drain nipple integrally formed with the support portion.

11. The drink holder of claim 5 further comprising a trim surface extending radially outward from the top of the second curved wall, the trim surface extending radially outward to the skirt portion, the skirt portion having attachment points for securing the drink holder to an adjoining structure.
